(19) United States
(12) Patent Application Publication
(10) Pub. No.: US 2018/0103171 A1
(43) Pub. Date: Apr. 12, 2018

(54) IMAGE READING DEVICE AND IMAGE FORMING APPARATUS

(71) Applicant: CANON KABUSHIKI KAISHA, Tokyo (JP)

(72) Inventor: Takayuki Fukushima, Toride-shi (JP)

(21) Appl. No.: 15/720,987

(22) Filed: Sep. 29, 2017

(30) Foreign Application Priority Data
Oct. 11, 2016 (JP) 2016-200408

(51) Int. Cl. H04N 1/028; H04N 1/00; H04N 1/12

(52) U.S. Cl. CPC H04N 1/0288; H04N 1/00602; H04N 1/00909; H04N 1/1235; H04N 1/00572; H04N 1/00615

(57) ABSTRACT

An image reading device includes a transparent member, a reading unit, and a sheet member provided on an upstream side, in a sheet conveyance direction, of the transparent member with respect to the reading position. The reading unit reads an image on a conveyed sheet via a reading position of the transparent member. The sheet member guides the conveyed sheet. The sheet member includes, in a sheet conveyance area in a sheet width direction orthogonal to the sheet conveyance direction, a first area where a leading edge of the conveyed sheet and the sheet member contact each other and a second area where the leading edge of the conveyed sheet and the sheet member do not contact each other.

### BACKGROUND OF THE INVENTION

### Field of the Invention

The present disclosure relates to an image reading device which reads an image on a sheet and an image forming apparatus including the same.

### Description of the Related Art

Conventionally, an image forming apparatus such as a copying machine or a facsimile machine including an image reading device, which optically reads an image on a document, has been known. This type of image reading device includes an auto document feeder (hereinafter referred to as ADF) which conveys documents one by one and a scanner unit which reads an image on the conveyed document via a transparent member. If a foreign substance has adhered to a surface of the transparent member, light emitted from the scanner unit is blocked by the foreign substance so that linear image noise (hereinafter referred to as an “image streak”) may occur in the read image information. The foreign substance can be roughly divided into two types. One type of foreign substance includes “stray dust particles” such as paper powder generated from the document and shavings from a conveyance roller which conveys the document. The other type of foreign substance is an “adhering dust” such as glue of a sticky note put on a document. For an image streak caused by the “stray dust particles”, a configuration in which the transparent member is electrically grounded to reduce an electrostatic adsorption force acting between the floating dust particles and the transparent member, and in which the floating dust particles, having adhered to the transparent member, are scraped off by a leading edge of the conveyed document to clean the transparent member has been known. On the other hand, for an image streak caused by the “adhering dust”, a configuration in which the adhering dust does not adhere to the transparent member is required because the adhering dust cannot be scraped off by the leading edge of the document once it adheres to the transparent member.

An image reading device in which a step sheet 810 is provided upstream in a document conveyance direction of reading glass 801, as illustrated in FIG. 8, is discussed (see Japanese Patent Application Laid-Open No. 2007-221589). In the image reading device, a conveyed document contacts the step sheet 810, and passes above the reading glass 801. Thus, contact between the document and the reading glass 801 is prevented.

However, due to this step provided on the reading glass 801, when a trailing edge of the conveyed document comes off the step sheet 810 and contacts the reading glass 801, vibrations in a vertical direction occurs as a result of an impact upon the contact to affect an image.

Japanese Patent Application Laid-Open No. 2012-134704 discusses an image reading device including a streak prevention sheet 918, as illustrated in FIG. 9. A downstream edge 918a of the streak prevention sheet 918 is formed so that the center and edge positions in a width direction orthogonal to a document conveyance direction differ from each other in the document conveyance direction. A reading line RL at an image reading position B is a position where a reading unit reads an image on a document. Let X4 be a distance from the reading line RL to a back portion 918aa of the downstream edge 918a of the streak prevention sheet 918 and from the reading line RL to a front portion 918ab of the downstream edge 918a. Let X5 be a distance from the reading line RL to a center 918ac of the downstream edge 918a. The distances X4 and X5 are set so that X4<X5. Thus, a trailing edge of the document, which passes through the downstream edge 918a, contacts a document flow-reading glass with a time lag. Thus, the trailing edge of the document is prevented from abutting on the document flow-reading glass simultaneously and strongly over an entire width direction, to prevent a reading pitch from becoming uneven.

However, in the configurations discussed in Japanese Patent Application Laid-Open No. 2007-22158 and Japanese Patent Application Laid-Open No. 2012-134704, the step sheet 810 and the streak prevention sheet 918 contact the conveyed document over the entire sheet width direction orthogonal to a sheet conveyance direction. Thus, the document is rubbed by the contact with the step sheet 810 or the streak prevention sheet 918, to generate paper powder. The paper powder may become “stray dust particles”.

### SUMMARY OF THE INVENTION

The present disclosure is directed to preventing paper powder from being generated by a sheet member and a conveyed sheet contacting each other.

According to an aspect of the present invention, an image reading device includes a transparent member, a reading unit configured to read an image on a conveyed sheet via a reading position of the transparent member, and a sheet member configured to guide the conveyed sheet and provided on an upstream side, in a sheet conveyance direction, of the transparent member with respect to the reading position, wherein the sheet member includes, in a sheet conveyance area in a sheet width direction orthogonal to the sheet conveyance direction, a first area where a leading edge of the conveyed sheet and the sheet member contact each other and a second area where the leading edge of the conveyed sheet and the sheet member do not contact each other.

Further features of the present invention will become apparent from the following description of embodiments with reference to the attached drawings.

### BRIEF DESCRIPTION OF THE DRAWINGS

FIG. 1 is an overall schematic view illustrating a printer according to an embodiment.

FIG. 2 is an overall side view illustrating an image reading device.

FIG. 3A is a side view illustrating an image reading section according to a first embodiment and FIG. 3B is a top view illustrating an image reading device according to the first embodiment.

FIG. 4 is a view illustrating a modification of a sheet member according to the first embodiment.

FIG. 5 is a view illustrating a sheet member having both ends positioned downstream of the center thereof and having a circular arc shape.

FIG. 6 is a view illustrating a sheet member having both ends positioned upstream of the center thereof and having a circular arc shape.

FIG. 7 is a side view illustrating an image reading device according to a third embodiment.

FIG. 8 is a side view illustrating a conventional image reading device according to a conventional technique.

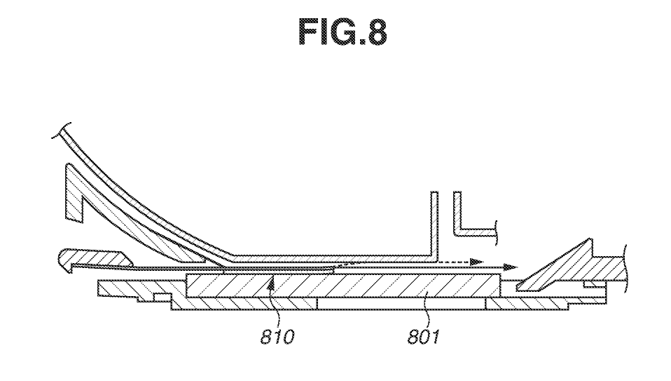

FIG. 9 is a top view of a conventional image reading device according to a conventional technique.

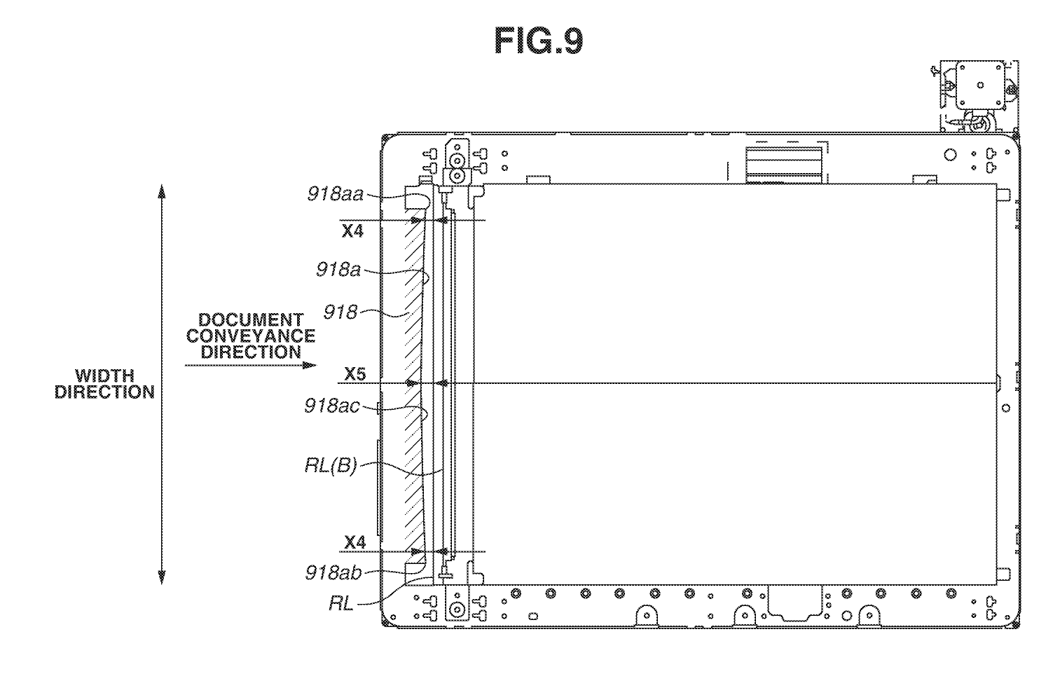

### DESCRIPTION OF THE EMBODIMENTS

### [Schematic Configuration of Printer]

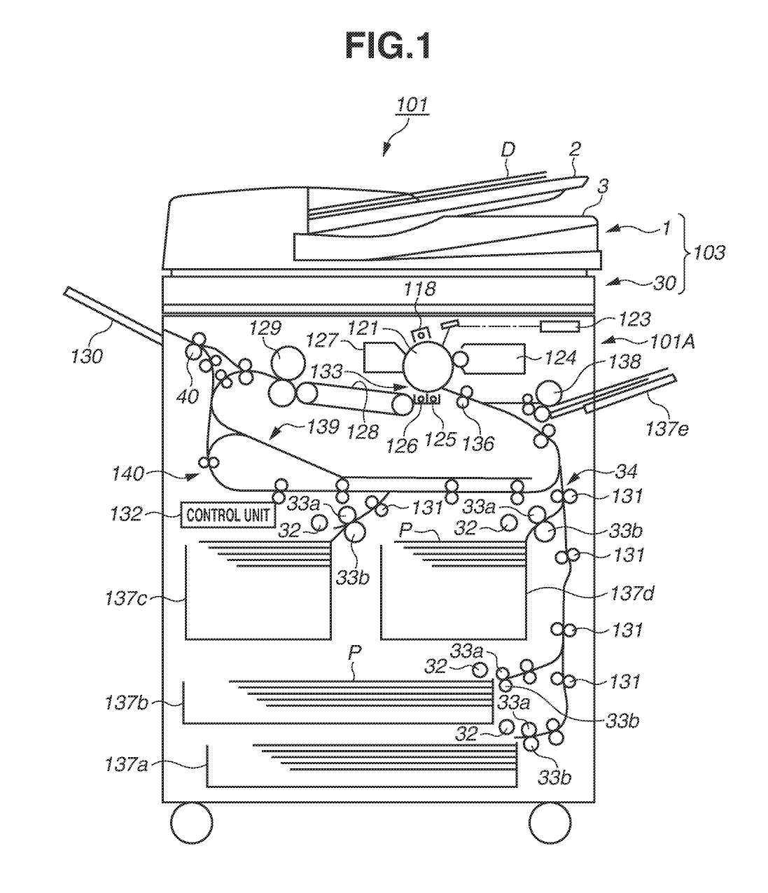

A schematic configuration of a printer 101 serving as an image forming apparatus will be described with reference to FIG. 1. The printer 101 includes a printer main body 101A and an image reading device 103, as illustrated in FIG. 1. The image reading device 103 arranged above the printer main body 101A includes an image reading device main body (hereinafter referred to as “device main body”) 30 and an auto document feeder (ADF) 1, and optically scans documents D and reads image information, as described below in detail. The document D includes paper such as a sheet and an envelope, a plastic film such as an overhead transparency (OHT), and a sheet such as a cloth. The image information, which has been converted into an electric signal by the image reading device 103, is transferred to a control unit 132 provided in the printer main body 101A.

The printer main body 101A includes an image forming section 133 which forms an image on sheets P each serving as a recording medium and a sheet feeding section 34 which feeds the sheets P to the image forming section 133. The sheet feeding section 34 includes sheet storage sections 137a, 137b, 137c, and 137d capable of respectively storing sheets P of different sizes. The sheets P stored in each of the sheet storage sections 137a, 137b, 137c, and 137d are drawn out by a pickup roller 32, are separated one by one by a feed roller 33a and a retard roller 33b, and are delivered to a corresponding conveyance roller pair 131. The sheets P are sequentially delivered to a plurality of conveyance roller pairs 131 arranged along a sheet conveyance path, to be conveyed to a registration roller pair 136.

The sheet P placed in a manual feed tray 137e by a user is fed into the printer main body 101A by a sheet feeding roller 138, and is conveyed to the registration roller pair 136. The registration roller pair 136 stops a leading edge of the sheet P to correct a skew while resuming the conveyance of the sheets P as an image formation operation, which is a process for forming a toner image by the image forming section 133, proceeds.

The image forming section 133, which forms an image on the sheet P, is an electrophotographic image forming unit including a photosensitive drum 121 serving as a photosensitive member. The photosensitive drum 121 is rotatable along a conveyance direction of the sheet P, and a charger 118, an exposure device 123, a development device 124, a transfer charger 125, a separation charger 126, and a cleaner 127 are arranged around the photosensitive drum 121. The charger 118 uniformly charges a surface of the photosensitive drum 121, and the exposure device 123 exposes the photosensitive drum 121 based on the image information input from the image reading device 103, to form an electrostatic latent image on the photosensitive drum 121.

The development device 124 stores a two-component developer containing toner and carrier, and supplies charged toner to the photosensitive drum 121, to develop the electrostatic latent image into a toner image. The toner image born on the photosensitive drum 121 is transferred onto the sheet P conveyed from the registration roller pair 136 by a bias electric field formed by the transfer charger 125. The sheet P onto which the toner image has been transferred is separated from the photosensitive drum 121 by a bias electric field formed by the separation charger 126, and is conveyed toward a fixing section 129 by a pre-fixing conveyance section 128. An adhering substance such as a transfer residual toner remaining on the photosensitive drum 121 without being transferred onto the sheet P is removed by the cleaner 127, and the photosensitive drum 121 prepares for a subsequent image formation operation.

The sheet P conveyed to the fixing section 129 is heated while being nipped and pressurized between a roller pair, and an image is fixed by melting and fixing the toner. The sheet P on which the image has been fixed is discharged onto a discharge tray 130 projecting outward from the printer main body 101A via a discharge roller pair 40. If an image is to be formed on a back surface of the sheet P in two-sided printing, the sheet P, which has passed through the fixing section 129, is conveyed to the registration roller pair 136 by a two-sided conveyance section 140 after front surface and the rear surface thereof are reversed by a reversing section 139. The sheet P, on which the image has been formed again by the image forming section 133, is discharged onto the discharge tray 130.

### [Image Reading Device]

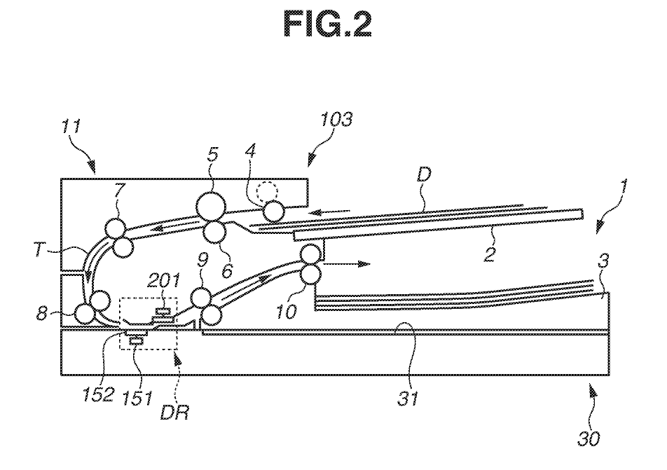

A configuration of the image reading device 103 will be described below with reference to FIG. 2. As illustrated in FIG. 2, the image reading device 103 includes a device main body 30 and the ADF 1 serving as a document feeding section. The image reading device 103 further includes a first reading unit 151 arranged in the device main body 30 and a second reading unit 201 arranged in the ADF 1. Each of elements constituting the image reading device 103 will be described below.

The first reading unit 151 is an example of a first reading section which reads image information from a first surface of the document D. The second reading unit 201 is an example of a second reading section which reads an image on a second surface on the opposite side to the first surface of the document D. The first surface in the present embodiment is a surface on the lower side of the document D in a two-sided reading section DR, and the second surface is a surface on the upper side of the document D in the two-sided reading section DR. The first reading unit 151 and the second reading unit 201 constitute the two-sided reading section DR capable of simultaneously reading both surfaces of the document D conveyed by the ADF 1. However, the two-sided reading section DR does not necessarily perform simultaneous reading of both surfaces of the document D but can also read only the one surface thereof.

Each of the first reading unit 151 and the second reading unit 201 includes a light source having a light emitting diode (LED) array arranged in a main scanning direction orthogonal to a conveyance direction of the document D (a sheet conveyance direction) and a plurality of light receiving elements similarly arranged in the main scanning direction. Light emitted from the LED array and reflected by the document D forms an image on each of the light receiving elements via a lens, and is photoelectrically converted by the light receiving element. Thus, the image on the document D can be obtained as image information.

The device main body 30 is fixed to an upper surface of the printer main body 101A (see FIG. 1). A flatbed document platen 31 is arranged, as illustrated in FIG. 2, on an upper surface of the device main body 30. The first reading unit 151 is supported on a carriage (not illustrated) movable in a horizontal direction in the drawing, and is movable over the entire length of the document platen 31 along the document platen 31 from a predetermined position (an illustrated position) in the two-sided reading section DR.

The ADF 1 is supported to be openable or closable in a vertical direction with respect to the device main body 30 by a hinge mechanism (not illustrated) arranged toward the back side in the drawing. The ADF 1 includes a document feeding tray 2 and a document conveyance section in addition to the second reading unit 201. The document feeding tray 2 supports the documents D placed thereon by the user. The document conveyance section 11 has a document conveyance path T formed therein, and feeds the documents D placed on the document feeding tray 2 to the two-sided reading section DR via the document conveyance path T.

The document conveyance section 11 will be described in detail. The document conveyance section 11 includes a pickup roller 4, a feed roller 5, a retard roller 6, a registration roller pair 7, conveyance roller pairs 8 and 9, and a discharge roller pair 10 in this order along a document conveyance direction (indicated by an arrow in the drawing) which also is the sheet conveyance direction. The pickup roller 4 is movable in the vertical direction with respect to an upper surface of the document feeding tray 2, and starts feeding while abutting on the documents D on the document feeding tray 2. The feed roller 5 conveys the document D received from the pickup roller 4 toward the downstream side in the conveyance direction. The retard roller 6 is pressed against the feed roller 5, receives as input rotation in a direction opposite to the conveyance direction via a torque limiter, and separates the documents D conveyed by the feed roller 5 one by one.

The registration roller pair 7 contacts a downstream edge (hereinafter referred to as a leading edge) in the conveyance direction of the document D conveyed by the feed roller 5 with rotation stopped, and deflects the document D to correct a skew of the document D. The registration roller pair 7 conveys the document D the skew of which has been corrected via a bend portion of the document conveyance path T, and delivers the conveyed document D to the conveyance roller pair 8. The conveyance roller pair 8 feeds the document D into the two-sided reading section DR, and delivers the fed document D to the conveyance roller pair 9 downstream of the two-sided reading section DR. At this time, the first reading unit 151 and the second reading unit 201 read an image on the document D. The conveyance roller pair 9 delivers the document D, which has passed through the two-sided reading section DR, to the discharge roller pair 10. The discharge roller pair 10 discharges the document D to a document discharge section 3.

The image reading device 103 thus configured reads the image information from the document D using a document flow-reading mode for scanning a document image while conveying the document D by the ADF 1 and a document fixed-reading mode for scanning the document D placed on the document platen 31. The document flow-reading mode is selected when the image reading device 103 has detected the documents D placed on the document feeding tray 2 or when the user has explicitly issued an instruction using an operation panel in the printer main body 101A. In this case, the ADF 1 feeds the documents D toward the two-sided reading section DR one by one with the first reading unit 151 existing at a predetermined position of the two-sided reading section DR. Both the first reading unit 151 and the second reading unit 201 emit scanning light onto the document D to scan the document D at the time of two-sided simultaneous reading while one of the first reading unit 151 and the second reading unit 201 emits scanning light onto the document D to scan the document D at the time of one-sided reading. Image information, which has been converted into an electric signal by the light receiving element in each of the first reading unit 151 and the second reading unit 201, is transferred to the control unit 132 in the printer main body 101A.

On the other hand, the document fixed-reading mode is selected when the image reading device 103 has detected the documents D placed on the document platen 31 or when the user has explicitly issued an instruction using the operation panel in the printer main body 101A. In this case, the first reading unit 151 emits light while moving along the document platen 31, and scans the document D placed on the document platen 31. Image information, which has been converted into an electric signal by the light receiving element in the first reading unit 151, is transferred to the control unit 132 in the printer main body 101A.

### [Image Reading Section]

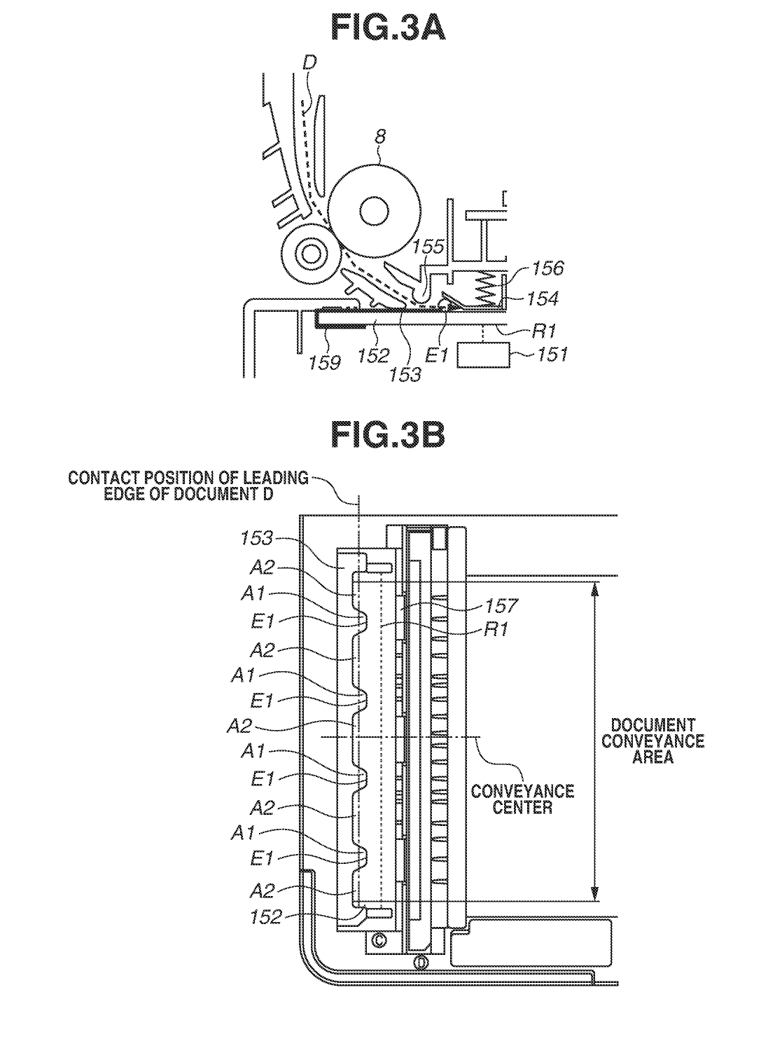

A configuration for reading particularly the first surface of the document D by the two-sided reading section DR will be described below. The configuration for reading the first surface is illustrated in FIGS. 3A and 3B. The configuration for reading the first surface includes a transparent member 152, the first reading unit 151 which reads an image on a sheet conveyed via a reading position R1 of the transparent member 152, and a sheet member 153 which guides the conveyed document D and is provided on the transparent member 152 upstream of the reading position R1. The reading position R1 is a position where an image on the document D is read by the first reading unit 151 in the case of the document flow-reading mode. The transparent member 152 is made of glass. The sheet member 153 is made of a polyethylene film. In addition to the polyethylene film, stainless also can be used.

A dust such as glue of a sticky note or ink (hereinafter referred to as an adhering dust) sometimes adheres to the conveyed document D. When the document D contacts the transparent member 152, the adhering dust adheres to the transparent member 152. The adhering dust, which has adhered to the transparent member 152, blocks light from the first reading section when it exists on the reading position R1. In such a case, an image streak by the adhering dust may occur. A sheet member is arranged at a position upstream in the sheet conveyance direction of the transparent member 152 so that the conveyed document D can pass above the transparent member 152. In this way, the document D can be prevented from contacting the transparent member 152. Thus, the adhering dust can be prevented from adhering to the transparent member 152.

On the other hand, when the sheet member 153 rubs against the document D, a surface of the document D is scraped. Thus, paper powder, which is one type of stray dust particles, may be generated. When the generated paper powder moves on the transparent member 152 by being carried by the conveyed document D or by opening and closing of the ADF 1, and is conveyed to the reading position R1, an image streak by the paper powder occurs. An effect of the image streak by the paper powder can be reduced by electrically grounding the transparent member 152 to reduce an electrostatic adsorption force acting between the paper powder and the transparent member 152. However, to more effectively prevent the image streak by the paper powder from occurring, a contact area between the sheet member 153 and the document D needs to be reduced so as to reduce an amount of paper powder to be generated.

In the present embodiment, a shape of the sheet member 153 which guides the document D conveyed to the first reading unit 151 and is arranged on the transparent member 152 is devised. The sheet member 153 includes, in a document conveyance area, a first area A1 where the leading edge of the conveyed document D and the sheet member 153 contact each other and a second area A2 where the leading edge of the conveyed document D and the sheet member 153 do not contact each other. The document conveyance area refers to an area through which a document of a maximum size to be guaranteed, as a product, by the image reading device 103 passes in a document width direction (sheet width direction) orthogonal to the conveyance direction of the document D.

In the sheet conveyance direction, a position where the leading edge of the document D contacts the sheet member 153 is a position where the document D and the sheet member 153 always contact each other. By reducing an area where the leading edge of the document D and the sheet member 153 contact each other, an amount of paper powder to be generated before the document D is conveyed to an end E1 of the sheet member 153 can be reduced. The contact position between the leading edge of the conveyed document D and the sheet member 153 can be checked by a sliding friction trace formed in the sheet member 153 when the plurality of documents D are fed by the ADF 1. The contact position between the leading edge of the conveyed document D and the sheet member 153 can be adjusted by changing a shape of a guide provided upstream of the reading position R1, as needed.

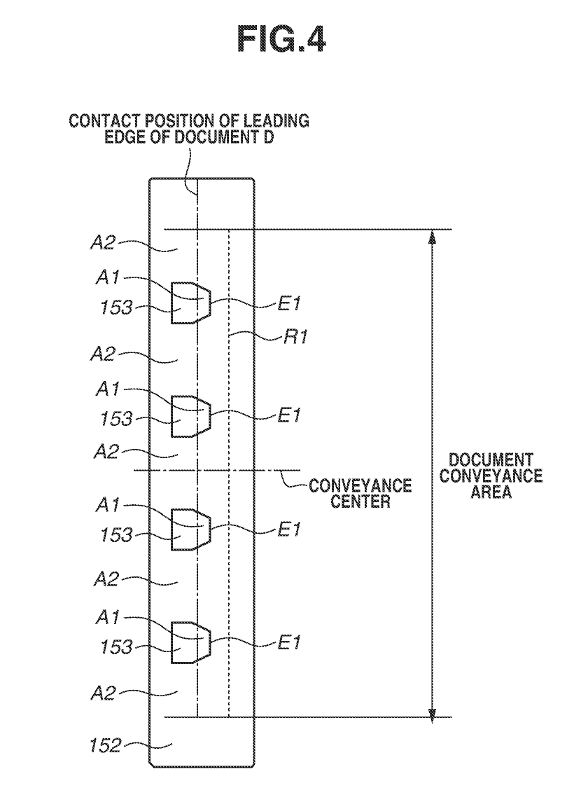

A neutralization member 159 made of aluminum is electrically connected to the bottom of the sheet member 153, and is grounded. Thus, a document conveyance surface, which abuts on the document D, of the sheet member 153, is neutralized, to prevent paper powder from adhering to the sheet member 153. In the present embodiment, the one sheet member 153 constitutes the first area A1 and the second area A2. Thus, when the neutralization member 159 is provided in at least a part of the sheet member 153, the entire document conveyance surface can be neutralized. Or instead, the sheet member 153 may be divided into a plurality of sheet members 153 in the document width direction to provide a first area A1 and a second area A2, as illustrated in FIG. 4. If the sheet member 153 is divided into the plurality of sheet members 153, each of the sheet members 153 obtained by the division is provided with a neutralization member so that the document conveyance surface can be neutralized.

The sheet member 153 functions to guide the document D conveyed by the conveyance roller pair 8 to the reading position R1. Therefore, the sheet member 153 is arranged upstream of the reading position R1 of the transparent member 152. Thus, the guided document D enters a predetermined clearance (0.4 mm) formed by the platen guide 154 and the transparent member 152. One surface of the document D guided to the reading position R1 is read by the first reading unit 151, and is converted into image information. The platen guide 154 is pressurized downward in a direction of gravity by an urging member 156 to prevent the document D conveyed at the time of document reading from floating. The predetermined clearance is formed, as described above, by a clearance holding section (not illustrated) between the platen guide 154 and the transparent member 152. For the conveyed document D to reliably enter a focal depth range of the first reading unit 151, the first reading unit 151 is pressurized against the transparent member 152 by an urging member (not illustrated), to determine a position of the first reading unit 151 in the direction of gravity. Thus, even if the first reading unit 151 reads the conveyed document D, an image is not blurred.

A shape of the sheet member 153 will be described below. The length of the sheet member 153 at a downstream end thereof in the document conveyance direction decreases in the document width direction toward the document conveyance direction. Thus, as the document D advances in the document conveyance direction, an area where the document D and the sheet member 153 contact each other decreases. Thus, a trailing edge of the document D gradually comes off the sheet member 153 so that vibration caused when the trailing edge of the document D comes off the sheet member 153 can be reduced.

On the other hand, a protrusion 155 is arranged above the first area A1 in the direction of gravity, and a clearance formed between the first area A1 and the protrusion 155 is as small as 0.6 mm. Thus, the conveyed document D and the protrusion 155 contact each other so that the movement of the document D can be restricted. Since the clearance between the first area A1 and the protrusion 155 is very small, a shock caused when the trailing edge of the document D comes off the conveyance roller pair 8 and a shock caused when the leading edge of the document D enters an inclined guiding member 157 are suppressed, to stabilize a behavior of the document D. Since the behavior of the document D is stabilized, an amount of color misregistration of a read image can be reduced. The first area A1 where the leading edge of the conveyed document D and the sheet member 153 contact each other includes a plurality of first areas A1. The plurality of first areas A1 includes at least two areas A1 existing on one side with respect to the center of the document conveyance area. Thus, the adhering dust is prevented from adhering to the transparent member 152 regardless of a document width, and paper powder can be prevented from being generated by the sheet member 153 and the document D contacting each other. The first areas A1 on the one side with respect to the center of the document conveyance area and the first areas A1 on the other side thereof are made the same in number. Thus, states of the generation of the paper powder in the sheet width direction on the one side and the other side can be made similar.

A second embodiment is similar in configuration to the first embodiment except for a shape of a sheet member 153. Therefore, description of the similar configuration will be omitted.

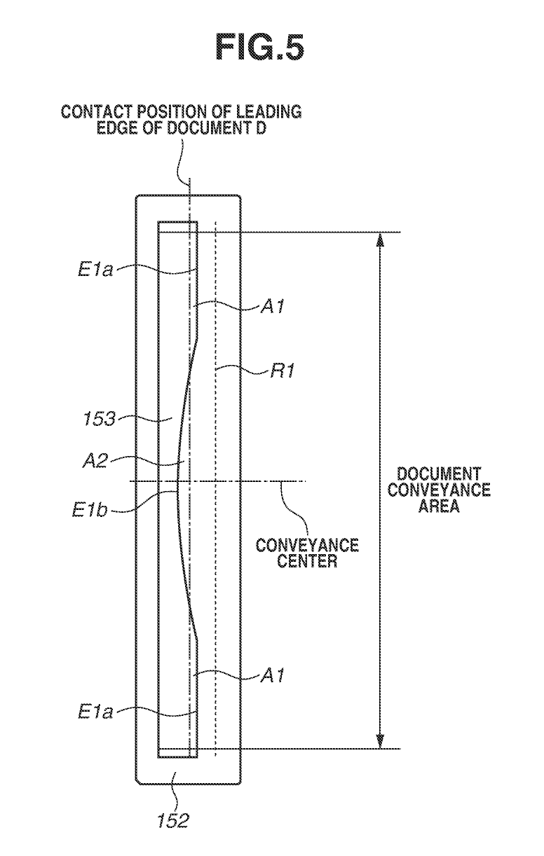

The sheet member 153 according to the second embodiment is configured to have a circular arc shape as illustrated in FIG. 5. Ends E1a are ends of the sheet member 153 on a downstream side in the sheet conveyance direction and located at ends of the sheet conveyance area in the sheet width direction. An end E1b is an end of the sheet member 153 on the downstream side in the sheet conveyance direction and located at a center of the sheet conveyance area in the sheet width direction. At this time, the sheet member 153 is configured in a circular arc shape so that the end E1b is positioned upstream of the ends E1a in the sheet conveyance direction. That is, the sheet member 153 includes a first area A1 where a leading edge of a conveyed document and the sheet member 153 contact each other and a second area A2 where the leading edge of the conveyed document and the sheet member 153 do not contact each other. In this way, a contact area between the document D and the sheet member 153 can be reduced. An adhering dust can be prevented from adhering to a transparent member 152, and paper powder can be prevented from being generated by the sheet member 153 and the document D contacting each other, like in the first embodiment.

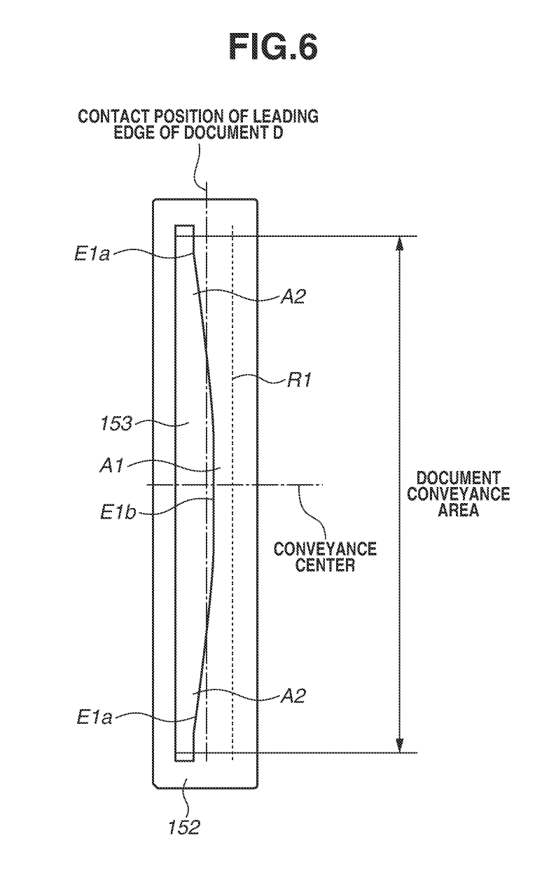

As a modification to the second embodiment, a configuration illustrated in FIG. 6 may be used. In FIG. 6, a sheet member 153 is configured in a circular arc shape so that ends E1a are positioned upstream of an end E1b in a sheet conveyance direction. Even if the sheet member 153 is thus configured, a similar effect is obtained.

A third embodiment is similar in configuration to the first embodiment except that a sheet member 153 is provided is on a support member 158 which supports a transparent member 152. Therefore, description of the similar configuration will be omitted.

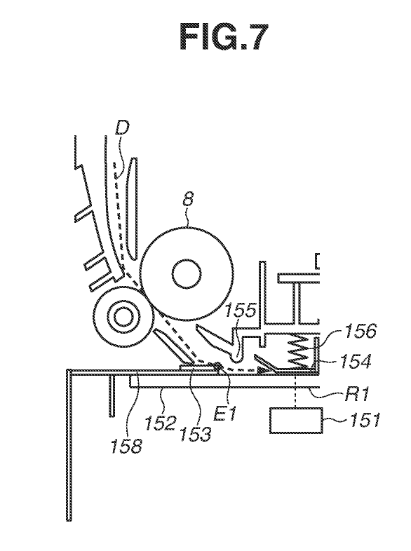

A configuration according to the third embodiment is illustrated in FIG. 7.

A configuration for reading a first surface includes the transparent member 152, the support member 158 which supports the transparent member 152, a first reading unit 151 which reads an image on a sheet conveyed via a reading position R1 of the transparent member 152, and the sheet member 153 which guides a conveyed document D and is provided on the support member 158 upstream of the reading position R1. A shape of the sheet member 153 is similar to that in the configuration described in FIG. 3B. The sheet member 153 includes a first area A1 where a leading edge of the conveyed document D and the sheet member 153 contact each other and a second area A2 where the leading edge of the conveyed document D and the sheet member 153 do not contact each other in a document conveyance area in a document width direction orthogonal to a conveyance direction of the document D. Thus, a contact area between the document D and the sheet member 153 can be reduced. Therefore, an amount of paper powder to be generated by an end E1 of the sheet member 153 and the conveyed document D being rubbed against each other can be reduced. In other words, as long as the leading edge of the conveyed document D contacts the sheet member 153 including the first area A1 and the second area A2, an effect is obtained regardless of where the sheet member 153 is arranged. Also, as long as the sheet member 153 includes the first area A1 and the second area A2, the effect can be obtained for the shape of the sheet member 153. Even in a configuration in which the sheet member 153 is provided on the support member 158, for example, the shape of the sheet member 153 may be the shapes as illustrated in FIGS. 4, 5, and 6.

While description has been made using an electrophotographic image forming apparatus in the above-described embodiments, the present invention is not limited to this. The present invention according to the embodiments may be applied to an ink jet image forming apparatus which forms an image on a sheet by discharging ink thereon instead of the electrophotographic image forming apparatus.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2016-200408, filed Oct. 11, 2016, which is hereby incorporated by reference herein in its entirety.

What is claimed is:

1. An image reading device comprising:
a transparent member;
a reading unit configured to read an image on a conveyed sheet via a reading position of the transparent member; and
a sheet member configured to guide the conveyed sheet and provided on an upstream side, in a sheet conveyance direction, of the transparent member with respect to the reading position,
wherein the sheet member includes, in a sheet conveyance area in a sheet width direction orthogonal to the sheet conveyance direction, a first area where a leading edge of the conveyed sheet and the sheet member contact each other and a second area where the leading edge of the conveyed sheet and the sheet member do not contact each other.

2. An image reading device comprising:
a transparent member;
a support member configured to support the transparent member;
a reading unit configured to read an image on a conveyed sheet via a reading position of the transparent member; and
a sheet member configured to guide the conveyed sheet and provided on an upstream side, in a sheet conveyance direction, of the support member with respect to the reading position,
wherein the sheet member includes, in a sheet conveyance area in a sheet width direction orthogonal to the sheet conveyance direction, a first area where a leading edge of the conveyed sheet and the sheet member contact each other and a second area where the leading edge of the conveyed sheet and the sheet member do not contact each other.

3. The image reading device according to claim 1, wherein ends of the sheet member on a downstream side of the sheet member in the sheet conveyance direction and located at ends of the sheet conveyance area in the sheet width direction are positioned downstream, in the sheet conveyance direction, of an end of the sheet member on the downstream side of the sheet member in the sheet conveyance direction and located at a center of the sheet conveyance area in the sheet width direction.

4. The image reading device according to claim 1, wherein ends of the sheet member on a downstream side in the sheet conveyance direction and located at ends of the sheet conveyance area in the sheet width direction are positioned upstream, in the sheet conveyance direction, of an end of the sheet member on the downstream side in the sheet conveyance direction and located at a center of the sheet conveyance area in the sheet width direction.

5. The image reading device according to claim 1, wherein an end of the sheet member on the downstream side in the sheet conveyance direction is formed in a circular arc shape.

6. The image reading device according to claim 1, wherein a length of the sheet member at a downstream end of the sheet member in the document conveyance direction decreases in the sheet width direction toward the sheet conveyance direction.

7. The image reading device according to claim 1, wherein the first area includes a plurality of first areas existing in the sheet conveyance area in the sheet width direction.

8. The image reading device according to claim 1, wherein the first area includes at least two first areas existing on one side with respect to a center of the sheet conveyance area in the sheet width direction.

9. The image reading device according to claim 1, wherein first areas existing on one side with respect to a center of the sheet conveyance area in the sheet width direction and first areas existing on the other side thereof are the same in number.

10. The image reading device according to claim 1, wherein the sheet member is formed as one member in the sheet conveyance area.

11. The image reading device according to claim 1, wherein the sheet member is divided into a plurality of sheet members in the sheet width direction.

12. The image reading device according to claim 1, wherein the sheet member is connected to a neutralization member for neutralizing the sheet.

13. The image reading device according to claim 2, wherein ends of the sheet member on a downstream side of the sheet member in the sheet conveyance direction and located at ends of the sheet conveyance area in the sheet width direction are positioned downstream, in the sheet conveyance direction, of an end of the sheet member on the downstream side of the sheet member in the sheet conveyance direction and located at a center of the sheet conveyance area in the sheet width direction.

14. The image reading device according to claim 2, wherein ends of the sheet member on a downstream side in the sheet conveyance direction and located at ends of the sheet conveyance area in the sheet width direction are positioned upstream, in the sheet conveyance direction, of an end of the sheet member on the downstream side in the sheet conveyance direction and located at a center of the sheet conveyance area in the sheet width direction.

15. The image reading device according to claim 2, wherein an end of the sheet member on the downstream side in the sheet conveyance direction is formed in a circular arc shape.

16. The image reading device according to claim 2, wherein a length of the sheet member at a downstream end of the sheet member in the document conveyance direction decreases in the sheet width direction toward the sheet conveyance direction.

17. The image reading device according to claim 2, wherein the first area includes a plurality of first areas existing in the sheet conveyance area in the sheet width direction.

18. The image reading device according to claim 2, wherein the first area includes at least two first areas existing on one side with respect to a center of the sheet conveyance area in the sheet width direction.

19. The image reading device according to claim 2, wherein first areas existing on one side with respect to a center of the sheet conveyance area in the sheet width direction and first areas existing on the other side thereof are the same in number.

20. The image reading device according to claim 2, wherein the sheet member is formed as one member in the sheet conveyance area.

21. The image reading device according to claim 2, wherein the sheet member is divided into a plurality of sheet members in the sheet width direction.

22. The image reading device according to claim 2, wherein the sheet member is connected to a neutralization member for neutralizing the sheet.
